(19) United States
(12) Patent Application Publication
(10) Pub. No.: US 2007/0063962 A1
(43) Pub. Date: Mar. 22, 2007

(54) Backlight for liquid crystal display and lighting control method therefor

(75) Inventors: Tsutomu Nanataki, Toyoake-city (JP); Iwao Ohwada, Nagoya-city (JP)

Correspondence Address: BURR & BROWN, PO BOX 7068, SYRACUSE, NY, 13261-7068, US

(73) Assignee: NGK Insulators, Ltd., Nagoya-City (JP)

(21) Appl. No.: 11/386,455

(22) Filed: Mar. 22, 2006

Related U.S. Application Data
(60) Provisional application No. 60/719,452, filed on Sep. 22, 2005.

(51) Int. Cl. G09G 3/36

(52) U.S. Cl. 345/102

(57) ABSTRACT

A backlight for a liquid crystal display including a plurality of liquid crystal display elements arranged in a matrix of n rows and m columns, in which optical transmittance of each of the liquid crystal display elements is changed, thereby switching an image every one frame period includes a plurality of electron-emitting elements and a phosphor. Each electron-emitting element is disposed to face a liquid crystal display element group including a plurality of adjacent liquid crystal display elements with the phosphor therebetween. In a sub-frame period divided from one frame period, each electron-emitting element accumulates and emits an amount of electrons according to the optical transmittance of each of the plurality of liquid crystal display elements facing each of the electron-emitting elements. In one frame period, the phosphor emits an amount of light which corresponds to the optical transmittance of the liquid crystal display elements a plurality of times.

### BACKGROUND OF THE INVENTION

1. Field of the Invention

The present invention relates to a backlight used for a liquid crystal display in which the optical transmittance is controlled by liquid crystal display elements, thereby switching an image to be displayed, and a lighting control method for the backlight.

2. Description of the Related Art

As known in the related art, a backlight for a liquid crystal display includes a plurality of tubular cold cathode discharge lamps that are arranged parallel to each other, as well as a diffusion plate and a plurality of diffusion sheets are disposed above the lamps (see, for example, Japanese Unexamined Patent Application Publication No. 2004-235103).

The backlight emits a constant amount of light by means of the cold cathode discharge lamps. The amount of light is set so that the brightest area of a displayed image has a sufficiently high brightness. Thus, if the displayed image includes dark and bright areas, the light emitted by means of the cold cathode discharge lamps corresponding to the dark area of the image are mostly blocked by liquid crystal display elements. Therefore, because the backlight of the related art emits an excessive amount of light, there arises a problem of excessive power consumption.

### SUMMARY OF THE INVENTION

It is an object of the present invention to provide a backlight with low power consumption in which an appropriate amount of light is emitted, according to an image to be displayed.

In an aspect of the present invention to achieve the aforementioned object, a backlight used for a liquid crystal display including a plurality of liquid crystal display elements arranged in a matrix of n rows and m columns, in which the optical transmittance of each of the plurality of liquid crystal display elements is changed at every elapse of one frame period, thereby switching an image to be displayed by the plurality of liquid crystal display elements includes an electron-emitting device, a phosphor, and a drive voltage applying circuit.

The electron-emitting device comprises a plurality of electron-emitting elements including an emitter section formed of a dielectric material; a lower electrode disposed below the emitter section; and an upper electrode disposed above the emitter section so as to face the lower electrode with the emitter section therebetween, the upper electrode having a plurality of fine through-holes, wherein each of the electron-emitting elements accumulates an amount of electrons on the emitter section when a predetermined write voltage is applied between the upper electrode and the lower electrode, the amount of electrons accumulated corresponding to the magnitude of the predetermined write voltage, and emits the electrons accumulated on the emitter section through the fine through-holes from the emitter section when a predetermined electron emission voltage is applied between the upper electrode and the lower electrode. The electron-emitting elements are arranged in a matrix so that each of the electron-emitting elements faces each of liquid crystal display element groups including a plurality of the liquid crystal display elements of the liquid crystal display that are adjacent to each other.

The phosphor is disposed between the upper electrode of the electron-emitting elements and the liquid crystal display so as to face the upper electrode(s), the phosphor emitting light by collisions with electrons.

The one frame period is divided into a plurality of sub-frame periods. In each of the sub-frame period, the drive voltage applying circuit determines a write voltage for each of the electron-emitting elements on the basis of the optical transmittances of the liquid crystal display elements belonging to the liquid crystal display element group that each of the plurality of electron-emitting elements faces with the phosphor therebetween, applies the determined write voltage to each of the electron-emitting elements, and, subsequently, applies the electron emission voltage to all of the plurality of electron-emitting elements.

Accordingly, in a sub-frame period, an amount of electrons corresponding to the optical transmittances of a plurality of liquid crystal display elements (e.g., the average value of the transmittances of the liquid crystal display elements) belonging to one of the liquid crystal display element groups are emitted from an electron-emitting element disposed that faces the one of the liquid crystal display element groups with the phosphor therebetween. Thus, the phosphor (or a portion of the phosphor) disposed so as to face one of the liquid crystal display element groups can emit an amount of light corresponding to the optical transmittances of the plurality of liquid crystal display elements belonging to the one of the liquid crystal display element groups. As a result, for example, the phosphor (or a portion of the phosphor) facing a liquid crystal display element group that is to display a dark area of a displayed image emits a smaller amount of light than the phosphor (or a portion of the phosphor) facing a liquid crystal display element group that is to display a bright area of the display image. Thus, the amount of excessive light that is otherwise mostly blocked by the liquid crystal display elements can be reduced, and a backlight with low power consumption can be provided.

Further, the liquid crystal display elements represent (displays) a dark area of the displayed image by blocking a small amount of light emitted from the phosphor (or a portion of the phosphor), and represent a bright area of the displayed image by transmitting a large amount of light emitted from the phosphor (or a portion of the phosphor). Consequently, a liquid crystal display to which the backlight according to the present invention is applied can provide a displayed image with higher contrast.

In this case, preferably, the value n is a multiple of an integer N of 2 or more, the value m is a multiple of an integer M of 2 or more, the liquid crystal display element groups are arranged in a matrix of n/N rows and m/M columns, n/N being given by dividing n by N, m/M being given by dividing m by M, the liquid crystal display is configured to perform an operation for changing the optical transmittances of all of the plurality of liquid crystal display elements in the one frame period by sequentially performing row scanning that needs a constant time, and the sub-frame period is set to be a period needed (required) for row scanning for the N rows of the liquid crystal display elements.

This embodiment corresponds to a case in which the electron-emitting device is configured such that electron-emitting elements are arranged in a matrix of n/N rows and m/M columns. If the time needed for row-scanning for one row of liquid crystal display elements is represented by Tg, a frame period Tf is given by n·Tg, and a sub-frame period is given by (N·Tg). In such a sub-frame period, the drive voltage applying circuit applies both a write voltage and an electron emission voltage. It is therefore possible to control the lighting of the phosphor in synchronization with the row-scanning timing of the liquid crystal display.

The drive voltage applying circuit may be configured to, in each sub-frame period, apply the write voltage to all of the electron-emitting elements by sequentially performing row scanning in which the write voltage is applied simultaneously to electron-emitting elements belonging to an identical row in the electron-emitting elements arranged in the matrix, and, thereafter, to apply the electron emission voltage simultaneously to all of the electron-emitting elements.

Accordingly, electrons are accumulated in electron-emitting elements on a row-by-row basis by performing so-called “row-scanning”, and the accumulation of electrons can be finished in a short time even if the backlight includes a large number of electron-emitting elements. Further, the electron-emitting elements have the “memory effect” (a function for maintaining the amount of electrons accumulated as it is)” in which, once electrons are accumulated, the accumulated electrons are not emitted unless a voltage equal to or greater than a predetermined electron emission voltage (such a voltage that the potential of the upper electrode is higher than the potential of the lower electrode and that polarization reversal starts to occur in the emitter section) is applied, and in which no additional electrons are accumulated unless a voltage equal to or less than a predetermined write voltage (such a voltage that the potential of the upper electrode is lower than the potential of the lower electrode and that polarization reversal starts to occur in the emitter section) is applied. Therefore, unlike liquid crystal display elements or the like, no switching element for permitting or prohibiting the supply of an image control signal at the time of row scanning is required. By performing row scanning on the electron-emitting elements, a desired amount of electrons can be accumulated in a large number of electron-emitting elements in a short time with low-cost circuitry. It is therefore possible to increase the number of sub-frame periods in one frame period and to increase the number of light emissions per frame.

Consequently, the backlight can change the amount of lighting in one light emission of the phosphor (a portion of the phosphor) corresponding to each electron-emitting element depending on the write voltage, and in addition, it can also select light emission or non-light emission of the phosphor for every sub-frame period. Thus, the range of reproducible gradation levels can considerably be improved. Assuming that the transmittance that can be controlled by a liquid crystal display element group has A levels, the amount of light emission of the phosphor has B levels, and the number of light emission (opportunities) in one frame period is C, the gradation of a conventional liquid crystal display device has a range of A levels, whereas the gradation of the backlight according to the present invention has a range of A×B×C levels. Therefore, the gradation reproduction performance of the liquid crystal display is greatly improved, and a displayed image with enhanced visualization can be provided.

The backlight having the structure described above not only improves the gradation reproduction performance of the liquid crystal display, but also employs a video display technique depending on the type of the image to be displayed. That is, for example, video signals corresponding to two consecutive frames (two consecutive displayed images) with respect to time are compared. If a difference between these video signals is large, the displayed image is defined as a “moving picture image”; if the difference is small, the displayed image is defined as a substantially “still image”. With the definition, if the displayed image is a “moving picture image”, the number of light emissions and the light emission timings are limited (adjusted) while considering delay in changing the liquid-crystal molecular orientation (the liquid crystal alignment) of liquid crystal display elements, thereby preventing blurring of the displayed image due to delay of the liquid crystal the liquid-crystal molecular orientation. If the displayed image is a “still image”, light is emitted in each sub-frame period, and the amount of light emission in each sub-frame period is controlled, thereby displaying a high-quality image with the maximum utilization of the above-described gradation reproduction performance.

According to the backlight with the structure described above, in combination with a mechanism for identifying image types (moving picture image and still image), with the use of suitable display techniques for the individual video images, high-quality images (video images) can be provided.

In another aspect of the present invention, there is provided a lighting control method for the backlight that is performed in the backlight.

### BRIEF DESCRIPTION OF THE DRAWINGS

FIG. 1 is a schematic partial cross-sectional view of a liquid crystal display device according to an embodiment of the present invention;

FIG. 2 is a plan view of a liquid crystal display shown in FIG. 1;

FIG. 3 is a plan view of an electron-emitting device shown in FIG. 1;

FIG. 4 is an enlarged partial cross-sectional view of the liquid crystal display, the electron-emitting device, and a light-emitting section shown in FIG. 1;

FIG. 5 is an enlarged partial plan view of an upper electrode shown in FIG. 4;

FIG. 6 is a diagram showing a state of the electron-emitting element shown in FIG. 4;

FIG. 7 is a voltage-polarization characteristic graph of an emitter section shown in FIG. 4;

FIG. 8 is a diagram showing another state of the electron-emitting element shown in FIG. 4;

FIG. 9 is a diagram showing another state of the electron-emitting element shown in FIG. 4;

FIG. 10 is a diagram showing another state of the electron-emitting element shown in FIG. 4;

FIG. 11 is a diagram showing another state of the electron-emitting element shown in FIG. 4;

FIG. 12 is a diagram showing another state of the electron-emitting element shown in FIG. 4;

FIG. 13 is a graph showing a relationship between a write voltage of the electron-emitting element shown in FIG. 4 (a drive voltage during an electron accumulation period) and the amount of light emission of a phosphor;

FIG. 14 is a graph showing a relationship between an electron emission voltage of the electron-emitting element shown in FIG. 4 (a drive voltage during a lighting period) and the amount of light emission of the phosphor;

FIG. 15 is a circuit diagram of a drive voltage applying circuit of the electron-emitting device shown in FIG. 1;

FIG. 16 is a time chart showing a relationship between row scanning for liquid crystal display elements in the liquid crystal display device shown in FIG. 1 and lighting control for the backlight;

FIG. 17 is a diagram showing lighting control for the backlight according to the present invention;

FIG. 18 is a schematic diagram showing the states, in plan view, of the light-emitting section obtained by the lighting control for the backlight according to the present invention;

FIG. 19 is a graph showing a relationship between a change in the transmittance of the liquid crystal display elements and the lighting period of the light-emitting section (the electron emission period of the electron-emitting device), according to the present invention; and

FIG. 20 is a partial cross-sectional view of a modified example of the light-emitting section shown in FIG. 1.

### DESCRIPTION OF THE PREFERRED EMBODIMENTS

Embodiments of a liquid crystal display device to which a backlight and a lighting control method for the backlight according to the present invention are applied will be described with reference to the drawings. In this document, the terms “accumulation of electrons” and “writing of electrons” are synonymously used.

(Structure)

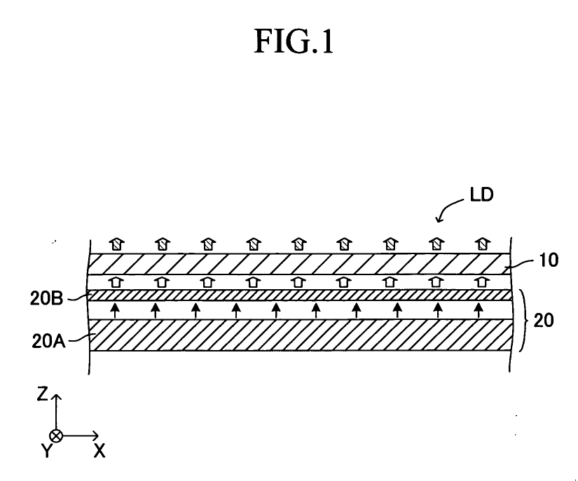

FIG. 1 is a schematic partial cross-sectional view of the liquid crystal display device LD. The liquid crystal display device LD includes a liquid crystal display 10 and a backlight 20. The liquid crystal display 10 is disposed above the upper surface of the backlight 20 (in the positive Z-axis direction).

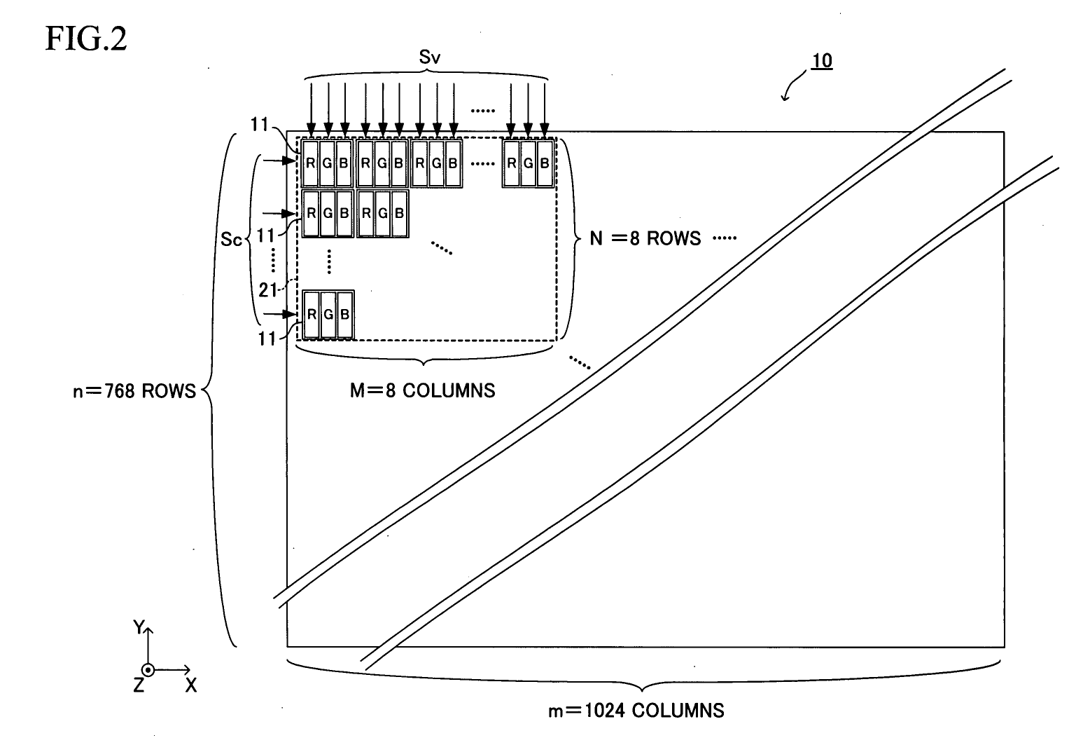

FIG. 2 is a plan view of the liquid crystal display 10. The shape of the liquid crystal display 10 in plan view is rectangular. The liquid crystal display 10 is a known liquid crystal display in which liquid crystal display elements 11 are arranged in a matrix of 768 rows (n rows) and 1024 columns (m columns). Each of the liquid crystal display elements 11 is composed of a red liquid crystal element R, a green liquid crystal element G, and a blue liquid crystal element B.

The red liquid crystal element R is provided with a red filter for transmitting red light included in white light, and is adapted to change the transmittance of red light transmitted through the red filter by liquid-crystal molecular orientation control (alignment control). The green liquid crystal element G is provided with a green filter for transmitting green light included in white light, and is adapted to change the transmittance of green light transmitted through the green filter by liquid-crystal molecular orientation control. The blue liquid crystal element B is provided with a blue filter for transmitting blue light included in white light, and is adapted to change the transmittance of blue light transmitted through the blue filter by liquid-crystal molecular orientation control.

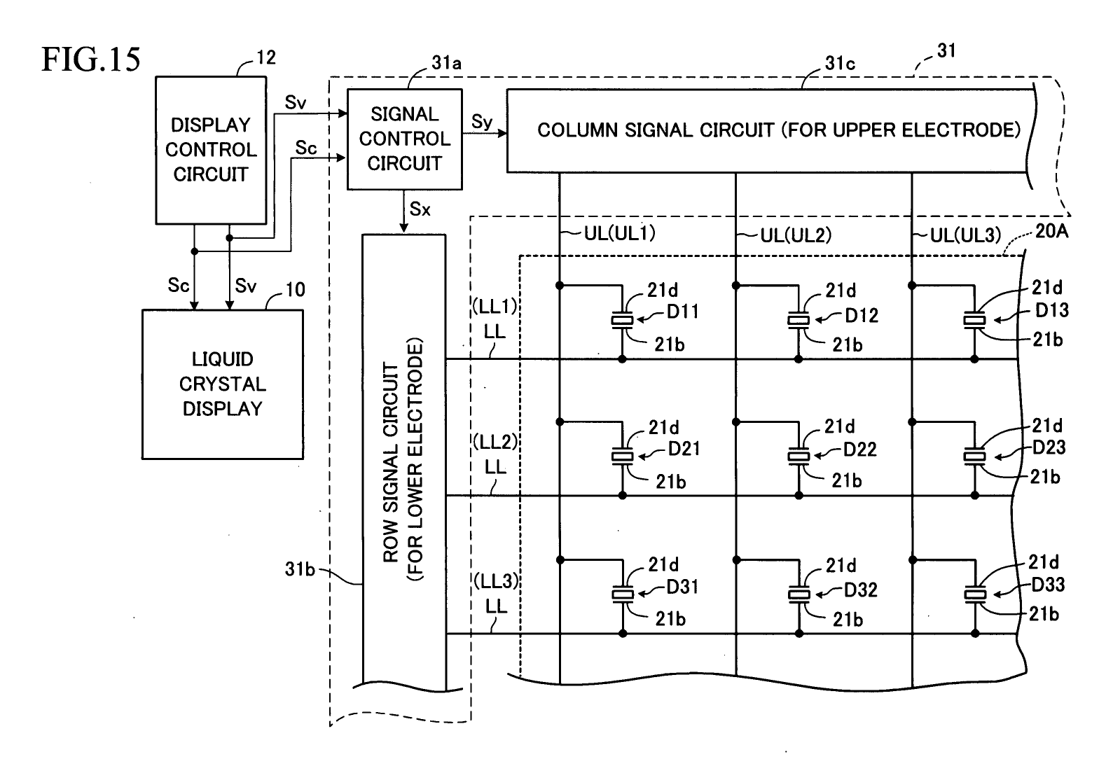

A row scanning signal (row selecting signal) Sc is fed (sent) to the liquid crystal display elements 11 belonging to an identical row from a display control circuit which is not shown (see FIG. 15). An image control signal Sv corresponding to each of the red liquid crystal element R, the green liquid crystal element G, and the blue liquid crystal element B is fed (sent) to the liquid crystal display elements 11 belonging to an identical column from the display control circuit.

As shown in FIG. 1, the backlight 20 has an electron-emitting device 20A, and a light-emitting section 20B disposed above the electron-emitting device 20A.

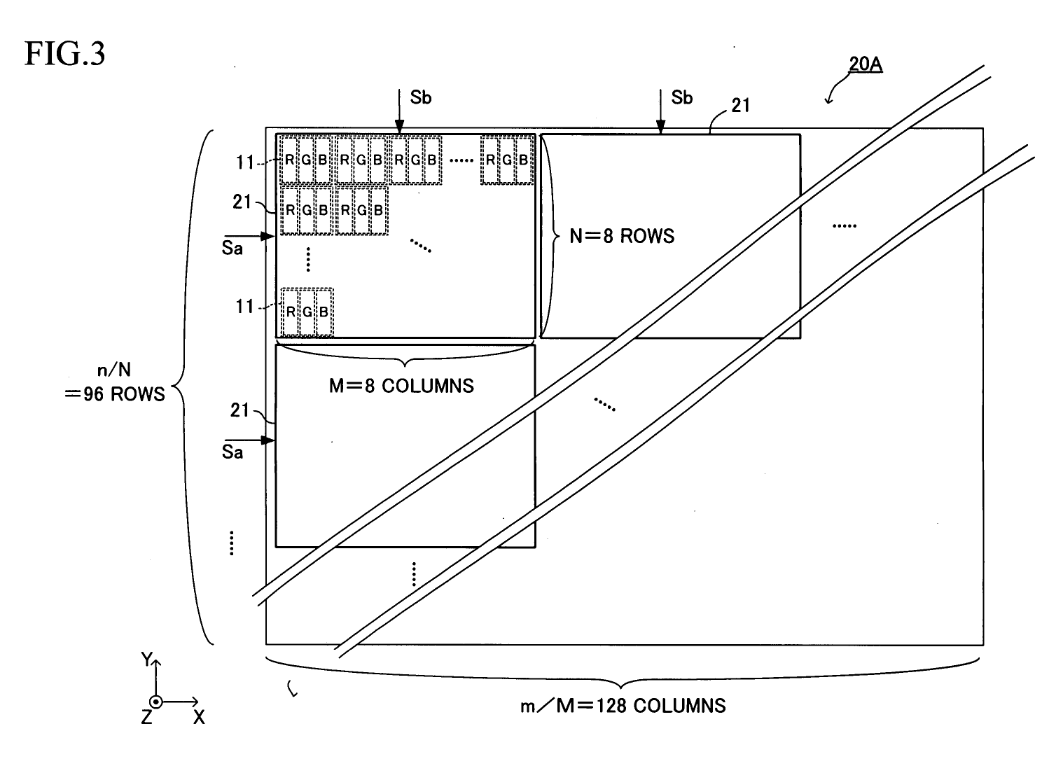

The electron-emitting device 20A is provided with a plurality of electron-emitting elements 21, as shown in FIGS. 2 and 3. FIG. 3 is a plan view of the electron-emitting device 20A. Each of the electron-emitting elements 21 is disposed so as to face a liquid crystal display element group composed of a plurality of liquid crystal display elements 11 arranged in a matrix of 8 rows (N rows) and 8 columns (M columns) (namely, 64 liquid crystal display elements 11). That is, the plurality of electron-emitting elements 21 are arranged in a matrix of 96 rows (=n/N rows) and 128 columns (=m/M columns).

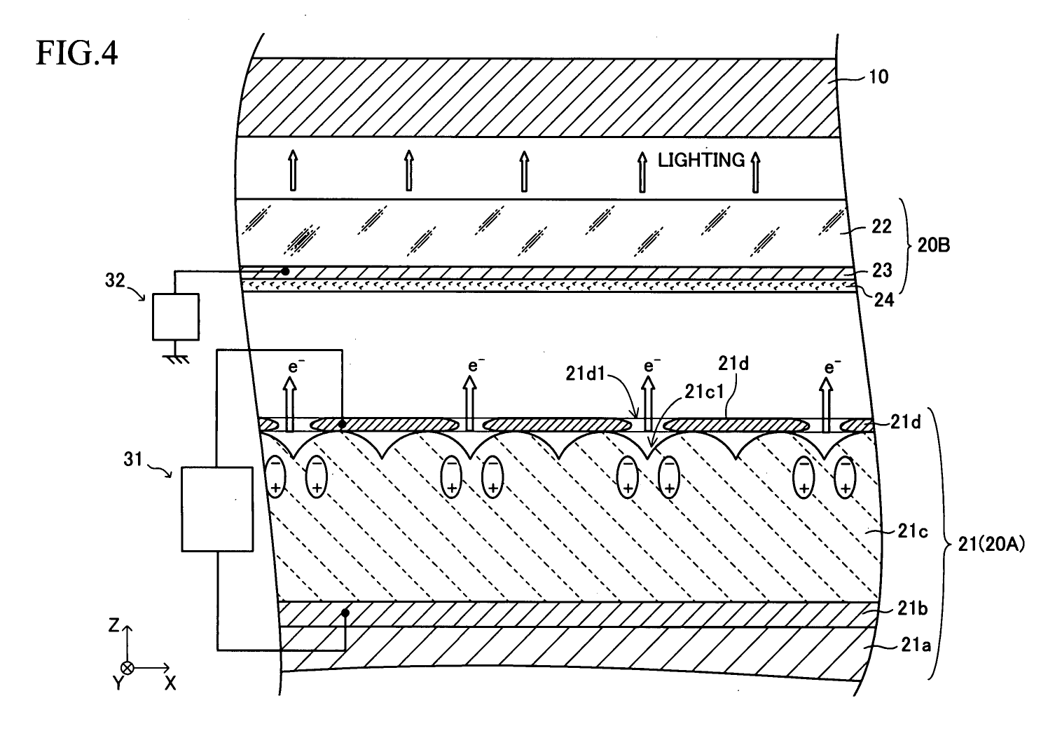

FIG. 4 is an enlarged partial cross-sectional view of the liquid crystal display 10, the electron-emitting device 20A, and the light-emitting section 20B. As shown in FIG. 4, the electron-emitting element 21 of the electron-emitting device 20A comprises a substrate 21a, a lower electrode (lower electrode layer) 21b, an emitter section 21c, and an upper electrode (upper electrode layer) 21d.

The substrate 21a is a thin plate having an upper surface and a lower surface that are parallel to a plane (X-Y plane) defined by orthogonal X- and Y-axes. The thickness direction of the plate corresponds to the Z-axis direction, the Z-axis being orthogonal to both the X- and Y-axes. The shape of the substrate 21a in plan view is rectangular, which is substantially the same as the liquid crystal display 10. The substrate 21a is formed of, for example, glass or a ceramic material (preferably, a material containing zirconium oxide as a major component).

The lower electrode 21b is formed of an electrically conductive material (here, silver or platinum), and is disposed in the form of a layer on the upper surface of the substrate 21a. The shape of the lower electrode 21b in plan view is a strip with a long side extending in the X-axis direction. The length of the lower electrode 21b in the Y-axis direction (that is, the width of the strip) is substantially the same as the length of a liquid crystal display element group, described above, in the Y-axis direction (that is, the length is about eight times the length of the liquid crystal display element 11 in the Y-axis direction).

The emitter section 21c is formed of a ferroelectric material (here, a ternary PMN-PT-PZ material including lead magnesium niobate (PMN), lead titanate (PT), and lead zirconate (PZ)), and is disposed on the upper surface of the lower electrode 21b above the substrate 21a. The emitter section 21c is a thin plate whose thickness direction corresponds to the Z-axis direction, and has substantially the same rectangular shape as the substrate 21a in plan view. Irregularities 21c1 due to the grain boundaries of the ferroelectric material are formed on the upper surface of the emitter section 21c.

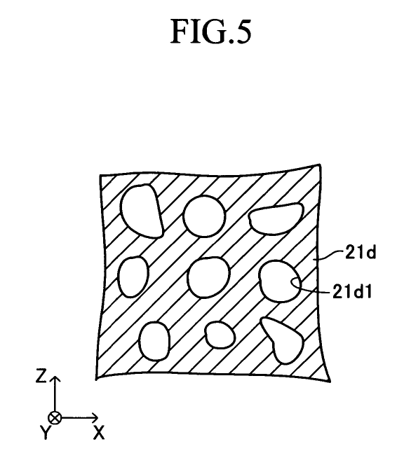

The upper electrode 21d is formed of an electrically conductive material (here, platinum), and is disposed in the form of a layer above the emitter section 21c (on the upper surface of the emitter section 21c) so as to face the lower electrode 21b with the emitter section 21c therebetween. The shape of the upper electrode 21d in plan view is a strip with a long side extending in the Y-axis direction. The length of the upper electrode 21d in the X-axis direction (that is, the width of the strip) is substantially the same as the length of a liquid crystal display element group, described above, in the X-axis direction (that is, the length is about eight times the length of the liquid crystal display element 11 in the X-axis direction). A plurality of fine through-holes 21d1 are formed in the upper electrode 21d, as shown in FIGS. 4 and 5. FIG. 5 is an enlarged partial plan view of the upper electrode 21d.

The thickness t of the upper electrode 21d ranges from 0.01 μm or more to 10 μm or less, and, preferably, from 0.05 μm or more to 1 μm or less. A surface corresponding to the peripheries of the fine through-holes 21d1 and facing the emitter section 21c is spaced a predetermined distance apart upward from the emitter section 21c. The maximum distance between the surface corresponding to the peripheries of the through-holes 21d1 (the edges of the through-holes) which faces the emitter section 21c and the emitter section 21c (the upper surface of the emitter section 21c) ranges from more than 0 μm to 10 μm or less, and, preferably, from 0.01 μm or more to 1 μm or less.

The lower electrode 21b, the emitter section 21c, and the upper electrode 21d which is formed of a platinum resinate paste are monolithically integrated by a baking process. The baking process for the integration reduces the thickness of the layer forming the upper electrode 21d, for example, from 10 μm to 0.1 μm. At this time, the plurality of fine through-holes 21d1 are formed in the upper electrode 21d.

As discussed above, the lower electrode 21b and the upper electrode 21d overlap (or are superimposed) each other in plan view. Overlapping portions of the lower electrode 21b and the upper electrode 21d form an individual electron-emitting elements 21 together with the emitter section 21c sandwiched between the lower electrode 21b and the upper electrode 21d in the overlapping portions. The lower electrode 21b and the upper electrode 21d are connected to a drive voltage applying circuit 31, which will be described in detail below, so that a drive voltage Vin is applied (a row voltage is sent on lines Sa shown in FIG. 3 to the lower electrode 21b and a column voltage is sent on lines Sb shown in FIG. 3 to the upper electrode 21d). Note that the drive voltage Vin is defined as a potential difference between the lower electrode 21b and the upper electrode 21d, wherein the potential of the lower electrode 21b is a reference (or a standard base) voltage.

As shown in FIG. 4, the light-emitting section 20B includes a transparent plate 22, a collector electrode 23, and a phosphor 24.

The transparent plate 22 is a thin plate having an upper surface and a lower surface that are parallel to each other. The thickness direction of the plate corresponds to the direction orthogonal to the upper and lower surfaces. The shape of the transparent plate 22 in plan view is rectangular, which is substantially the same as the liquid crystal display 10. The transparent plate 22 is formed of a transparent material (here, glass or an acrylic material). The transparent plate 22 is disposed above the electron-emitting elements 21 (in the positive Z-axis direction) at a predetermined distance apart from the upper surfaces of the electron-emitting elements 21 (the upper surface of the upper electrode 21d). The transparent plate 22 is disposed so that the lower surface of the transparent plate 22 is parallel to the plane defined by the upper electrode 21d (i.e., the plane defined by the electron-emitting sections of the electron-emitting elements 21).

The collector electrode 23 is formed of an electrically conductive material (here, a transparent conductive film of indium tin oxide (ITO)). The collector electrode 23 is disposed in the form of a layer on the entire lower surface of the transparent plate 22. A collector voltage applying circuit 32 is connected to the collector electrode 23 to apply a predetermined positive voltage Vc to the collector electrode 23. Thus, the collector electrode 23 generates an electric field that accelerates and attracts the electrons emitted from the electron-emitting elements 21.

The phosphor 24 is formed in the form of a layer so as to cover the collector electrode 23 on the lower surface of the transparent plate 22. When electrons collide with the phosphor 24, the phosphor 24 is excited by the electrons, and emits white light during the transition from the excitation state to the ground state. A typical example of such a white phosphor is a Y₂O₂S:Tb phosphor. Alternatively, the white phosphor may be manufactured by a mixture of phosphors including a red phosphor (e.g., Y₂O₂S:Eu), a green phosphor (e.g., ZnS:Cu, Al), and a blue phosphor (e.g., ZnS:Ag, Cl). The light emitted from the phosphor 24 is directed upward from the light-emitting section 20B through the transparent plate 22, and enters the liquid crystal display 10.

The space defined between the substrate 21a and the transparent plate 22 is maintained under substantial vacuum (of, preferably, 10² to 10⁻⁶ Pa, and, more preferably, 10⁻³ to 10⁻⁵ Pa). In other words, the substrate 21a and the transparent plate 22, together with sidewalls (not shown) of the electron-emitting device 20A, define an enclosed space. The electron-emitting elements 21 are therefore placed in the enclosed space maintained under substantial vacuum by the space-defining members.

The operation principle of the electron-emitting elements 21 having the structure described above will now be described.

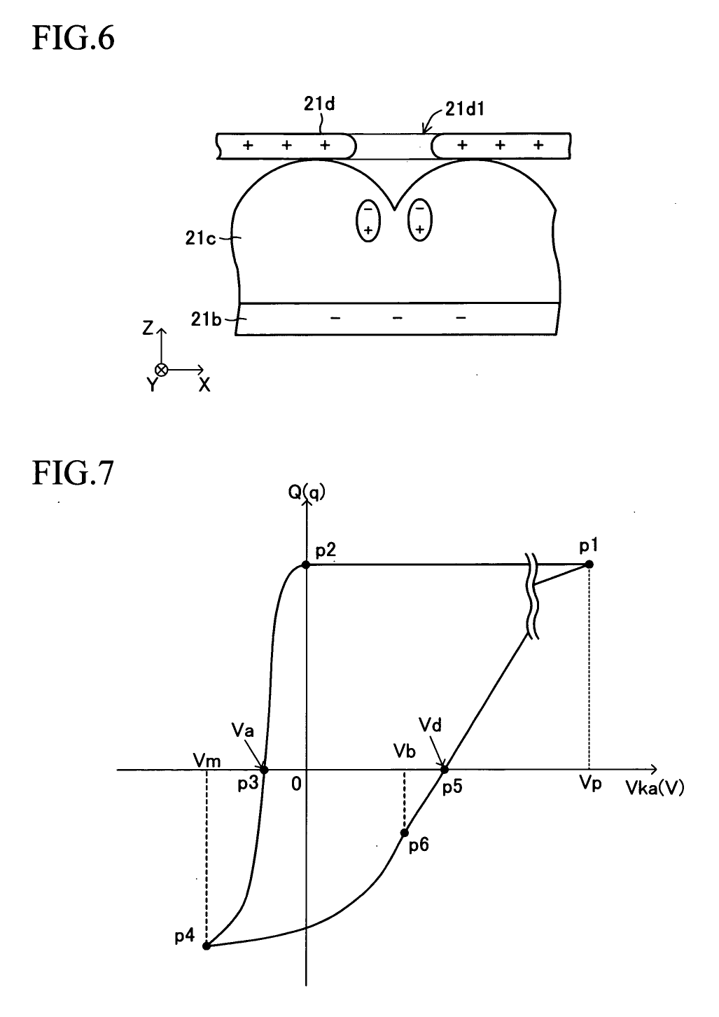

First, the description will start with the state in which, as shown in FIG. 6, an actual potential difference Vka (element voltage Vka) between the lower electrode 21b and the upper electrode 21d, the potential of the lower electrode 21b is a reference (or a standard base) voltage, is maintained at a predetermined positive voltage Vp and in which all electrons on (in) the emitter section 21c have been emitted so that no electrons are accumulated on the emitter section 21c. In this stage, the negative poles of dipoles of the emitter section 21c are directed toward the upper surface of the emitter section 21c (in the positive Z-axis direction, i.e., toward the upper electrode 21d). This state is a state at a point P1 on the graph shown in FIG. 7. FIG. 7 is a voltage-polarization characteristic graph of the emitter section 21c in which the axis of abscissa denotes the element voltage Vka and the axis of ordinate denotes the charge Q accumulated in the vicinity of the upper electrode 21d.

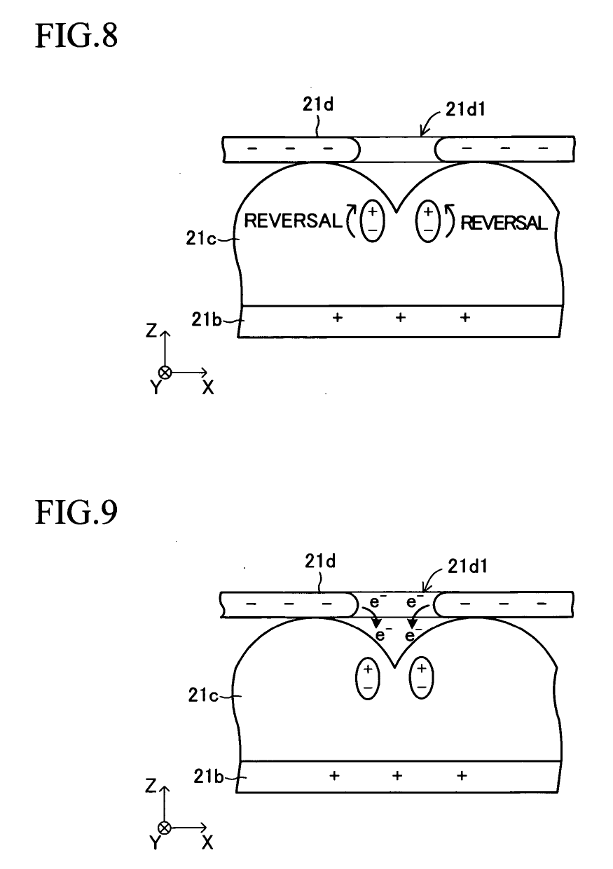

In this state, the drive voltage applying circuit 31 changes the drive voltage Vin to a write voltage (accumulation voltage) Vm, which is a predetermined negative voltage. The element voltage Vka thus decreases toward a point p3 via a point p2 in FIG. 7. When the element voltage Vka reaches a voltage close to a negative coercive field voltage Va (e.g., −10 V) shown in FIG. 7, the directions of the dipoles of the emitter section 21c start to reverse. That is, as shown in FIG. 8, polarization reversal (negative polarization reversal) starts to occur.

Due to the negative polarization reversal, the electric field increases (i.e., an electric field concentration occurs) at contact sites (triple junctions) between the upper surface of the emitter section 21c, the upper electrode 21d, and the ambient medium (in this case, vacuum) and/or at the distal end portions of the upper electrode 21d defining the fine through-holes 21d1. As a result, as shown in FIG. 9, electrons start to be supplied toward the emitter section 21c from the upper electrode 21d.

The supplied electrons are accumulated mainly in the upper portion of the emitter section 21c near the region exposed through the micro through hole 21d1 of the upper electrode 21d and near the distal end portions of the upper electrode 21d that define the micro through hole 21d1. Hereinafter, this portion where the supplied electrons are accumulated is simply referred to as the “portion in the vicinity of the fine through-holes 21d1”. Then, when the negative polarization reversal is completed after the elapse of a predetermined time, the element voltage Vka rapidly changes toward the predetermined negative voltage Vm, eventually reaching the predetermined negative voltage Vm. As a result, the accumulation of electrons is completed (i.e., the accumulation saturation of electrons occurs). This state is a state at a point p4 in FIG. 7.

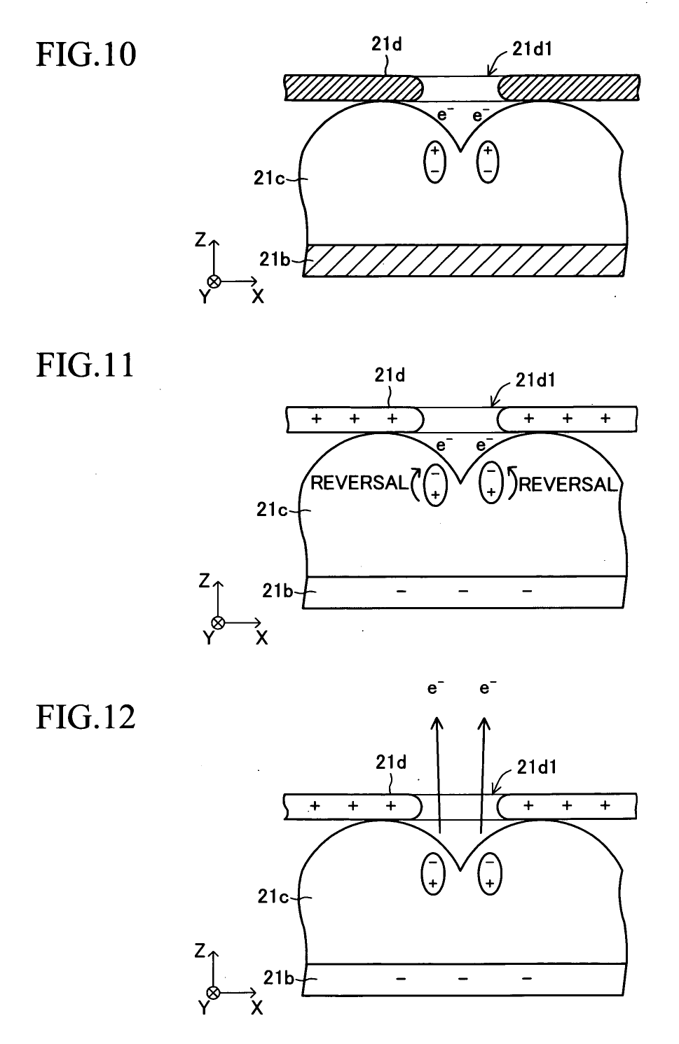

When an electron emission timing arrives, the drive voltage applying circuit 31 changes the drive voltage Vin to an electron emission voltage Vp, which is the predetermined positive voltage. The element voltage Vka thus starts to increase. In this stage, as shown in FIG. 10, the charge state of the emitter section 21c is maintained until the element voltage Vka reaches a voltage Vb (point p6) slightly lower than a positive coercive field voltage Vd (e.g., +50 V) corresponding to a point p5 in FIG. 7.

Then, the element voltage Vka reaches a voltage close to the positive coercive field voltage Vd. Thus, the negative poles of the dipoles start to be turned toward the upper surface of the emitter section 21c. That is, as shown in FIG. 11, the polarization is reversed again (i.e., positive polarization reversal starts to occur). This state is a state near the point p5 in FIG. 7.

Subsequently, at a time near a time at which the positive-side polarization reversal is completed, the number of dipoles having negative poles oriented toward the upper surface of the emitter section 21c increases. As a result, as shown in FIG. 12, the electrons accumulated on the emitter section 21c at the portion in the vicinity of the fine through-holes 21d1 start to be emitted upward (in the positive Z-axis direction) through the fine through-holes 21d1 by Coulomb repulsion. Since the large number of fine through-holes 21d1 are formed in the upper electrode 21d, a large number of electrons are emitted in a planar manner through the fine through-holes 21d1. The emitted electrons are applied to the phosphor 24 of the light-emitting section 20B. Thus, the phosphor 24 emits white light. The emitted light is directed upward through the transparent plate 22, and enters the liquid crystal display 10.

When the positive polarization reversal is completed, the element voltage Vka starts to rapidly increase, and electrons are actively emitted. Then, the emission of electrons is completed, and the element voltage Vka reaches the predetermined positive voltage Vp. As a result, the state of the emitter section 21c returns to the initial state shown in FIG. 6 (the state at the point p1 in FIG. 7). What has been described above is a series of operations for the accumulation of electrons (writing of electrons) and the emission of electrons (lighting of the phosphor).

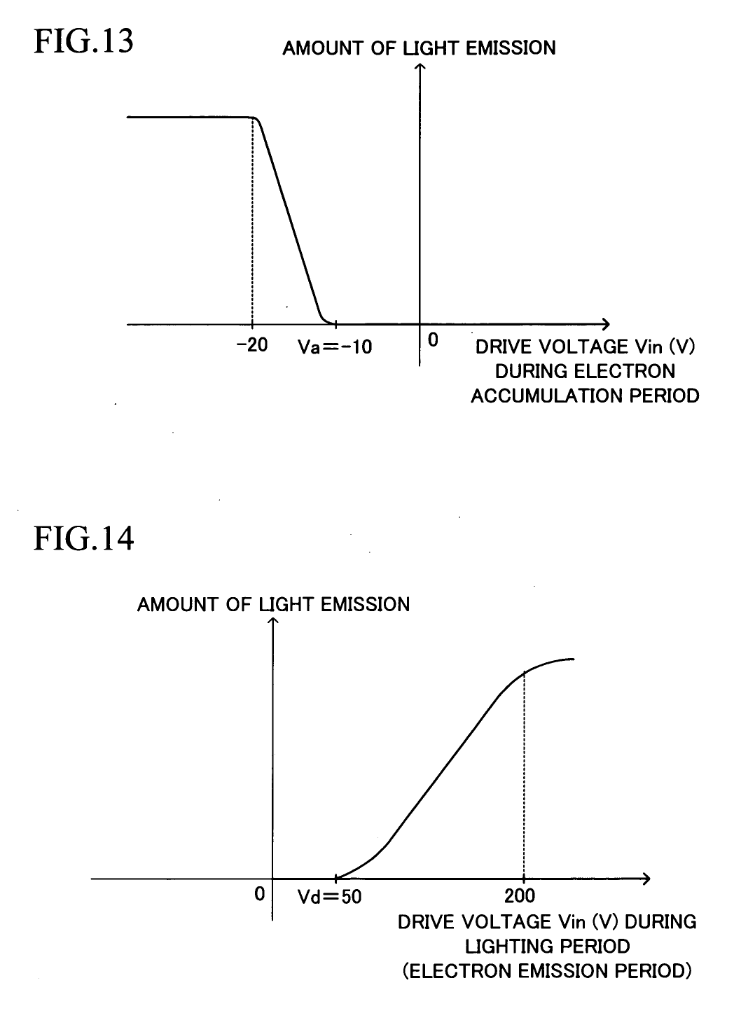

As described, in the electron-emitting elements 21, the negative polarization reversal does not occur unless the drive voltage Vin exceeds below the negative coercive field voltage Va (e.g., −10 V) (i.e., unless the drive voltage Vin becomes a negative voltage with magnitude greater than the absolute value of the negative coercive field voltage Va). Thus, the electrons to be emitted can not be accumulated on (or in) the emitter section 21c at the portion in the vicinity of the fine through-holes 21d1. Accordingly, the relationship between the write voltage of the electron-emitting elements 21 (the drive voltage Vin during the accumulation of electrons) and the amount of light emission of the phosphor 24 changes as shown in the graph of FIG. 13. As is understood from FIG. 13, the electron-emitting elements 21 are elements that can accumulate and emit the electrons more as the absolute value of the write voltage becomes larger, if the write voltage is within a predetermined range (a negative voltage range of, in this embodiment, −20 to −10 V).

Further, in the electron-emitting elements 21, positive polarization reversal does not occur unless the drive voltage Vin exceeds the positive coercive field voltage Vd (e.g., +50 V), and thus, the electrons accumulated on the emitter section 21c at the portion in the vicinity of the fine through-holes 21d1 are not emitted. Therefore, the relationship between the electron emission voltage of the electron-emitting elements 21 (the drive voltage Vin during the lighting) and the amount of light emission of the phosphor 24 changes as shown in the graph of FIG. 14.

Next, the drive voltage applying circuit 31 will be described in detail. As shown in FIG. 15, the drive voltage applying circuit 31 includes a signal control circuit 31a, a row signal circuit (row selecting circuit) 31b, and a column signal circuit (signal supplying circuit) 31c. In FIG. 15, the individual electron-emitting elements 21 are represented by reference numerals D11, D12, . . . D32, and D33. Note that the electron-emitting element 21 disposed in the x-th row and the y-th column is represented by reference numeral Dxy.

The signal control circuit 31a is connected to a display control circuit 12 which supplies the row scanning signal Sc and the image control signal Sv to the liquid crystal display elements 11 of the liquid crystal display 10. The signal control circuit 31a receives the row scanning signal Sc and the image control signal Sv.

The row signal circuit 31b is connected to the signal control circuit 31a, and receives a row signal control signal Sx from the signal control circuit 31a. The row signal circuit 31b is further connected to a plurality of row selecting lines LL. Each of the plurality of row selecting lines LL is connected to the lower electrode 21b of the electron-emitting elements 21 in the same row. For example, the row selecting line LL1 is connected to the lower electrode 21b of the elements D11, D12, D13, . . . in the first row; the row selecting line LL2 is connected to the lower electrode 21b of the elements D21, D22, D23, . . . in the second row; and the row selecting line LL3 is connected to the lower electrode 21b of the elements D31, D32, D33, . . . in the third row. In response to the row signal control signal Sx, the row signal circuit 31b applies a row voltage, which will be described below, to the lower electrode 21b of the electron-emitting elements 21 via the plurality of row selecting lines LL.

The column signal circuit 31c is connected to the signal control circuit 31a, and receives a column signal control signal Sy from the signal control circuit 31a. The column signal circuit 31c is further connected to a plurality of emission signal lines UL. Each of the emission signal lines UL is connected to the upper electrode 21d of the electron-emitting elements 21 in the same column. For example, the emission signal line UL1 is connected to the upper electrode 21d of the elements D11, D21, D31, . . . in the first column; the emission signal line UL2 is connected to the upper electrode 21d of the elements D12, D22, D32, . . . in the second column; and the emission signal line UL3 is connected to the upper electrode 21d of the elements D13, D23, D33, . . . in the third column. In response to the column signal control signal Sy, the column signal circuit 31c applies a column voltage, which will be described below, to the upper electrode 21d of the electron-emitting elements 21 via the plurality of emission signal lines UL.

(Operation)

Next, the operation of the thus constructed liquid crystal display device LD will be described. The display control circuit 12 performs row-scanning, which is known in the display technology using liquid crystal displays, to control the liquid-crystal molecular orientation (alignment of liquid crystals) of the liquid crystal display elements 11 (the red liquid crystal elements R, the green liquid crystal elements G, and the blue liquid crystal elements B) so that an image is displayed on the liquid crystal display 10.

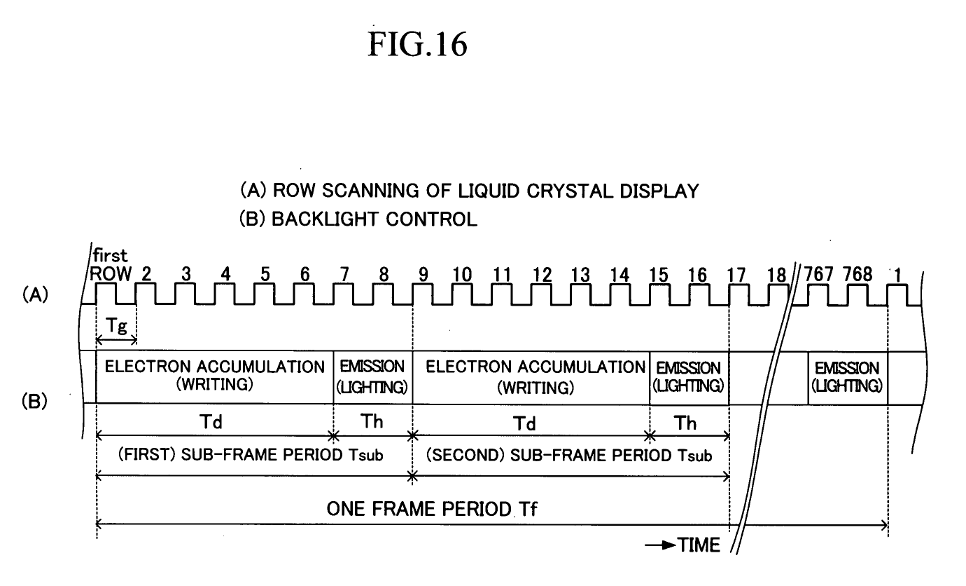

More specifically, the display control circuit 12 sets the row scanning signal Sc for a row to be row-scanned (i.e., for a selected row) at a predetermined voltage, and sets the row scanning signal Sc for the remaining rows at a different voltage. Therefore, a voltage based on the image control signal Sv is applied only to the liquid crystal display elements 11 in the row to be row-scanned. The display control circuit 12 sends the image control signal Sv so that the liquid crystal display elements 11 in the row to be row-scanned can achieve the individual transmittances for the image to be displayed. When the image control signal Sv is applied, the liquid crystal display elements 11 in the row to be row-scanned start to change the liquid-crystal molecular orientation (alignment of liquid crystals) so as to achieve the transmittance based on the image control signal Sv. After about ten milliseconds, the change of the orientation (alignment) is completed and the transmittance becomes stable (or constant). The row-scanning operation is repeatedly performed for the first to 768th rows in sequence (in the order of row number) at intervals of a constant time (Tg), as shown in (A) of FIG. 16.

As a result of row-scanning for the first to 768th rows, the transmittances of all of the liquid crystal display elements 11 of the liquid crystal display 10 are changed, and a new image of one frame is displayed. The period needed (or required) for row-scanning for the first to 768th rows is referred to as a “frame period (frame time) Tf”.

Meanwhile, the signal control circuit 31a that controls the backlight 20 performs an electron accumulation (writing) operation and an electron emission (light emission from the light-emitting section 20B) operation in a cycle of a sub-frame period Tsub. The sub-frame period Tsub is a period of time (8·Tg) needed for row-scanning for eight rows of the liquid crystal display 10. For example, a sub-frame period Tsub is a period for row-scanning for the first to eighth rows of the liquid crystal display 10, and the next sub-frame period Tsub is a period for row-scanning for the ninth to 16th rows of the liquid crystal display 10.

That is, the sub-frame period Tsub is a period starting at the time when the row scanning operation for all of the liquid crystal display elements 11 forming a liquid crystal display element group composed of 8 rows by 8 columns of liquid crystal display elements 11 is completed and ending at the time when the time (8·Tg) needed for row-scanning eight (8=N) rows of the liquid crystal display elements 11 has elapsed since the starting time.

When the signal control circuit 31a recognizes the start of a sub-frame period Tsub on the basis of the row scanning signal Sc input from the display control circuit 12, the signal control circuit 31a applies a write voltage to all of the electron-emitting elements 21 in the sub-frame period Tsub to accumulate electrons on the emitter section 21c. At this time, based on the image control signal Sv input from the display control circuit 12, the signal control circuit 31a obtains by calculation an average brightness of an image portion displayed by the liquid crystal display elements 11 belonging to a liquid crystal display element group corresponding to each of the electron-emitting elements 21 (a liquid crystal display element group disposed directly above each of the electron-emitting elements 21). That is, the signal control circuit 31a calculates the average value of the transmittances of the liquid crystal display elements 11 belonging to that liquid crystal display element group. Then, based on the brightness (the average value of the transmittances), the signal control circuit 31a determines the amount of electrons to be accumulated in each of the electron-emitting elements 21 (i.e., the write voltage).

To accumulate electrons on each of the electron-emitting elements 21, the signal control circuit 31a applies the determined write voltage between the upper electrode 21d and the lower electrode 21b by means of the row scanning method. When the row scanning for all rows is completed, the signal control circuit 31a applies the electron emission voltage between the upper electrode 21d and the lower electrode 21b of all of the electron-emitting elements 21 simultaneously. In a sub-frame period Tsub, therefore, an appropriate amount of electrons are emitted from all of the electron-emitting elements 21, and an appropriate amount of light is emitted from the portions of the phosphor 24 at the appropriate positions.

Note that, as discussed below, the signal control circuit 31a applies a voltage that prevents accumulation of electrons, as a write voltage, between the upper electrode 21d and the lower electrode 21b of the electron-emitting element 21 corresponding to a portion of the phosphor 24 that does not need to emit light (a portion of the phosphor 24 facing a liquid crystal display element group that is to represent an image portion without illumination, i.e., only in black).

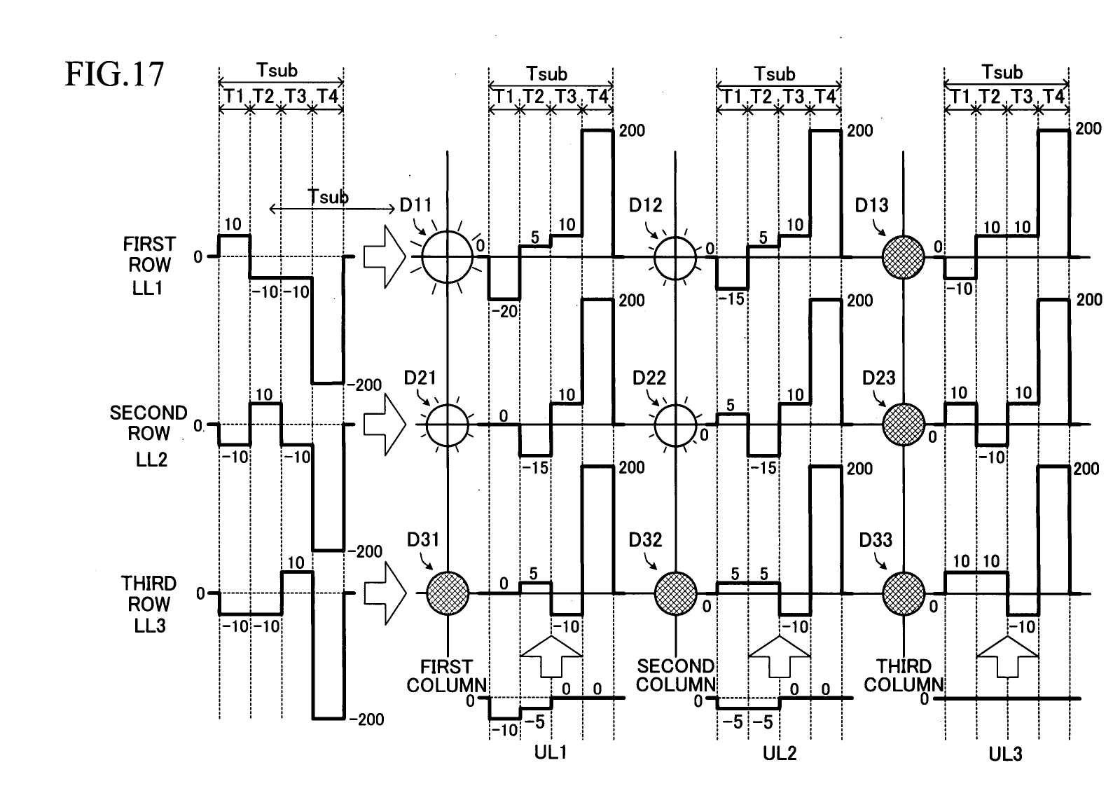

The details of the lighting control will be described with reference to FIG. 17 in the context of a specific example. In the specific example, it is assumed that the electron-emitting device 20A includes electron-emitting elements 21 arranged in a matrix of 3 rows and 3 columns.

It is also assumed that an image portion corresponding to the electron-emitting element (D11) located in the first row and the first column of the electron-emitting device 20A is very bright; image portions corresponding to the electron-emitting elements (D12, D21, and D22) located in the first row and the second column, the second row and the first column, and the second row and the second column are intermediately bright, and image portions corresponding to the electron-emitting elements (D13, D23, D31, D32, and D33) located at the remaining positions are only black (without illumination).

As shown in FIG. 17, a sub-frame period Tsub is divided into four sub-periods T1 to T4, and the signal control circuit 31a applies the drive voltage Vin that differs depending on the sub-period between the upper electrode 21d and the lower electrode 21b of the electron-emitting elements 21. Each of the sub-periods T1 to T3 corresponds to an electron accumulation period (electron writing period) Td, and the sub-period T4 corresponds to an electron emission period Th.

First, in the sub-period T1 immediately after the start of the sub-frame period Tsub, the signal control circuit 31a applies a row voltage of 10 V to the row selecting line LL1, a row voltage of −10 V to the row selecting line LL2, and a row voltage of −10 V to the row selecting line LL3 by means of the row signal circuit 31b. The row corresponding to the row selecting line to which a row voltage of 10 V is applied is a row to be row-scanned (a selected row, i.e., a row for which electrons are to be accumulated).

Simultaneously, in the sub-period T1, the signal control circuit 31a applies a column voltage of −10 V to the emission signal line UL1, a column voltage of −5 V to the emission signal line UL2, and a column voltage of 0 V to the emission signal line UL3 by means of the column signal circuit 31c.

As a result, a voltage of 10 V and a voltage of −10 V are applied to the lower electrode 21b and the upper electrode 21d of the electron-emitting element D11, respectively, and the drive voltage Vin (write voltage) applied to the electron-emitting element D11 is therefore −20 V. Thus, as is also understood from FIG. 13, a large amount of electrons substantially equal to the saturation amount are accumulated on the emitter section 21c of the electron-emitting element D11. The drive voltage Vin applied to the electron-emitting element D12 is −15 V. Thus, as is also understood from FIG. 13, an amount of electrons equal to about a half the saturation amount are accumulated on the emitter section 21c of the electron-emitting element D12. Meanwhile, the drive voltage Vin applied to the electron-emitting element D13 is −10 V. Thus, no electrons are accumulated in the electron-emitting element D13.

The drive voltages Vin applied to the electron-emitting elements in the second and third rows are as shown in FIG. 17. Given that the drive voltage applied to the electron-emitting element 21 located in the x-th row and the y-th column is represented by Vin(x, y), Vin(2, 1)=0 V, Vin(2, 2)=5 V, Vin(2, 3)=10 V, Vin(3, 1)=0 V, Vin(3, 2)=5 V, and Vin(3, 3)=10 V are obtained. Since those drive voltages Vin are voltages greater than the negative coercive field voltage Va, namely, −10 V, no electrons are accumulated on the emitter section 21c of those electron-emitting elements 21. By the operation described above, the row scanning operation for the first row of the electron-emitting device 20A ends.

Subsequently, in the sub-periods T2 and T3, the signal control circuit 31a sequentially applies row voltages and column voltages shown in FIG. 17 and Table 1 below to the row selecting lines LL1 to LL3 and the emission signal lines UL1 to UL3. As a result, the status of the accumulation of electrons in the electron-emitting elements is shown in Table 1 below.

TABLE 1

| Element | D11 | | Element | D12 | | Element | D13 | |
|---|---|---|---|---|---|---|---|---|
| Subperiod | T2 | T3 | Subperiod | T2 | T3 | Subperiod | T2 | T3 |
| LL1 | −10 (V) | −10 (V) | LL1 | −10 (V) | −10 (V) | LL1 | −10 (V) | −10 (V) |
| UL1 | −5 (V) | 0 (V) | UL2 | −5 (V) | 0 (V) | UL3 | 0 (V) | 0 (V) |
| Vin | 5 (V) | 10 (V) | Vin | 5 (V) | 10 (V) | Vin | 10 (V) | 10 (V) |
| Status | Accumulation | Accumulation | Status | Accumulation | Accumulated | Status | Non- | Non- |
| | continues | continues | | continues | continues | | accumulation | accumulation |
| Element | D21 | | Element | D22 | | Element | D23 | |
| Subperiod | T2 | T3 | Subperiod | T2 | T3 | Subperiod | T2 | T3 |
| LL2 | 10 (V) | −10 (V) | LL2 | 10 (V) | −10 (V) | LL2 | 10 (V) | −10 (V) |
| UL1 | −5 (V) | 0 (V) | UL2 | −5 (V) | 0 (V) | UL3 | 0 (V) | 0 (V) |
| Vin | −15 (V) | 10 (V) | Vin | −15 (V) | 10 (V) | Vin | −10 (V) | 10 (V) |
| Status | Small amount | Accumulation | Status | Small amount | Accumulation | Status | Non- | Non- |
| | accumulation | continues | | accumulation | continues | | accumulation | accumulation |
| Element | D31 | | Element | D32 | | Element | D33 | |
| Subperiod | T2 | T3 | Subperiod | T2 | T3 | Subperiod | T2 | T3 |
| LL3 | −10 (V) | 10 (V) | LL3 | −10 (V) | 10 (V) | LL3 | −10 (V) | 10 (V) |
| UL1 | −5 (V) | 0 (V) | UL2 | −5 (V) | 0 (V) | UL3 | 0 (V) | 0 (V) |
| Vin | 5 (V) | −10 (V) | Vin | 5 (V) | −10 (V) | Vin | 10 (V) | −10 (V) |
| Status | Non- | Non- | Status | Non- | Non- | Status | Non- | Non- |
| | accumulation | accumulation | | accumulation | accumulation | | accumulation | accumulation |

Subsequently, in the sub-period T4, the signal control circuit 31a applies a row voltage of −200 V to the row selecting lines LL1 to LL3, and applies a column voltage of 0 V to all of the emission signal lines UL1 to UL3. Therefore, the drive voltages Vin applied to all of the electron-emitting elements 21 are 200 V.

As a result, a large amount of electrons are emitted from the electron-emitting element D11 on which a large amount of electrons are accumulated, and the phosphor 24 (or the portion of the phosphor 24) disposed above the electron-emitting element D11 emits a large amount of light. The image portion corresponding to the electron-emitting element D11 is therefore displayed very brightly.

From the electron-emitting elements D12, D21, and D22 on which an amount of electrons equal to a half of the saturation amount has been accumulated, a smaller amount of electrons than the amount of electrons emitted from the electron-emitting element D11 are emitted. The phosphor 24 (or the portions of the phosphor 24) disposed above the electron-emitting elements D12, D21, and D22 emits an intermediate amount of light. The image portions corresponding to the electron-emitting elements D12, D21, and D22 are therefore displayed with normal brightness.

From the electron-emitting elements D13, D23, D31, D32, and D33 on which no electrons have been accumulated, no electrons are emitted. The image portions corresponding to those electron-emitting elements are therefore displayed in black.

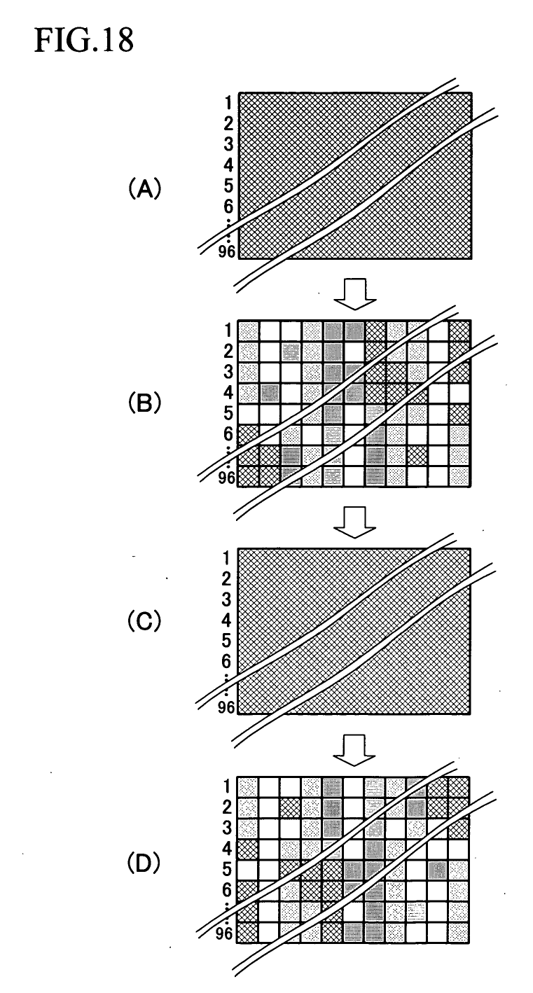

FIG. 18 is a schematic diagram showing the states, in plan view, of the light-emitting section 20B obtained by the control described above. In (A) of FIG. 18, the state of the light-emitting section 20B during the electron accumulation period Td (the sub-periods T1 to T3) in a sub-frame period Tsub is illustrated. In the electron accumulation period Td, the light-emitting section 20B does not emit light. Subsequently, in the electron emission period Th (the sub-period T4), as shown in (B) of FIG. 18, the electron-emitting elements 21 emit the electrons accumulated in the electron accumulation period Td, and the corresponding portions of the light-emitting section 20B emit light with brightness depending on the amount of electron emission of the electron-emitting elements 21.

Subsequently, likewise, in the electron accumulation period Td, the light-emitting section 20B does not emit light (see (C) in FIG. 18). Then, in the electron emission period Th, portions of the light-emitting section 20B emit light with brightness depending on the amount of electron emission of the electron-emitting elements 21 facing the portions (see (D) in FIG. 18).

As described above, by the backlight 20 of the liquid crystal display 10 and the method for controlling the backlight 20 according to the embodiment of the present invention, in a sub-frame period Tsub into which one frame period Tf is divided, an amount of electrons corresponding to the optical transmittances of a plurality of liquid crystal display elements 11 belonging to one of liquid crystal display element groups (for example, according to the average value of the transmittances of those liquid crystal display elements 11) are emitted from the electron-emitting element 21 which is disposed to face the one of the liquid crystal display element groups with the phosphor 24 therebetween.

Therefore, the phosphor 24 (or a portion of the phosphor 24) disposed so as to face one of liquid crystal display element groups emits an amount of light according to the optical transmittances of the plurality of liquid crystal display elements 11 belonging to the one of the liquid crystal display element groups. As a result, for example, the phosphor 24 (or a portion of the phosphor 24) facing a liquid crystal display element group that is to represent a dark area of a displayed image emits a smaller amount of light than the phosphor 24 (or a portion of the phosphor 24) facing a liquid crystal display element group that is to represent a bright area of the displayed image. Therefore, the amount of excessive light that is mostly blocked by the liquid crystal display elements 11 can be reduced, and the backlight 20 with low power consumption can be achieved.

Further, the liquid crystal display elements 11 represent (displays) a dark area of a displayed image by blocking a slight amount of light emitted from the phosphor 24 (or the portion of the phosphor), and represent a bright area of the displayed image by transmitting a large amount of light emitted from the phosphor 14 (or the portion of the phosphor). Consequently, the liquid crystal display 10 can provide a displayed image with higher contrast.

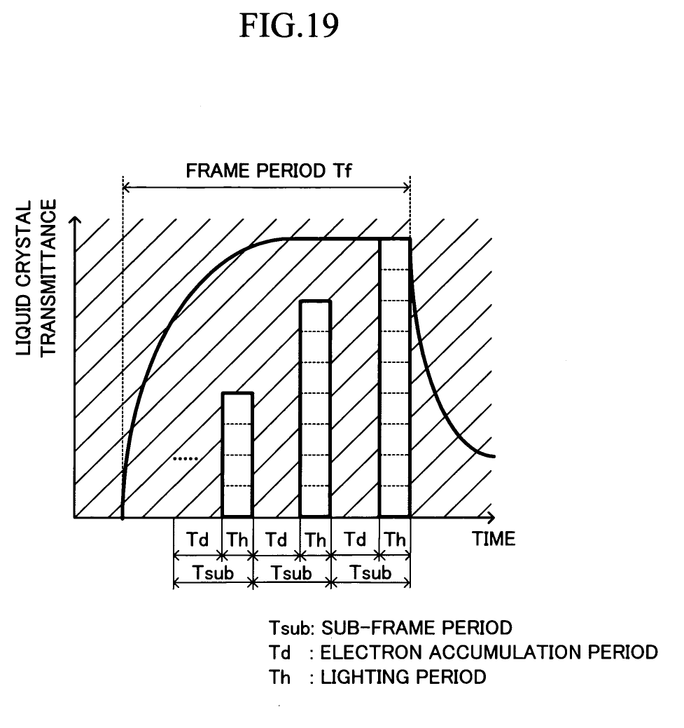

Furthermore, as is also understood from FIG. 19, the electron-emitting elements 21 can provide multiple levels of the amount of light emission (multiple ranges of the amount of light emission indicated by broken lines in FIG. 19), and also has a plurality of light emission opportunities (timings) in one frame period. Thus, the number of gradation levels that can be provided by the liquid crystal display 10 (liquid crystal display element groups) is given by the product of the number of transmittance levels (transmittance ranges) available from the individual liquid crystal display elements 11, the number of ranges of the amount of light emission, and the number of light emission opportunities in one frame period. That is, the gradation reproduction performance of the system is considerably improved.

Further, the backlight 20 of the above-described embodiment allows electrons to be accumulated in electron-emitting elements on a row-by-row basis by performing so-called “row scanning”. Therefore, if the backlight 20 includes a large number of electron-emitting elements, the accumulation of electrons can be completed in a short time. Further, the electron-emitting elements 21 have the “memory effect” in which, once electrons are accumulated, the accumulated electrons are not emitted unless a voltage equal to or greater than a predetermined electron emission voltage (such a voltage that the potential of the upper electrodes is higher than the potential of the lower electrodes and that polarization reversal starts to occur in the emitter sections, i.e., the positive coercive field voltage Vd) is applied, and in which no additional electrons are accumulated unless a voltage equal to or less than a predetermined write voltage (such a voltage that the potential of the upper electrodes is lower than the potential of the lower electrodes and that polarization reversal starts to occur in the emitter sections, i.e., the negative positive coercive field voltage Va) is applied.

Therefore, unlike liquid crystal display elements or the like, no switching element for permitting or prohibiting the supply of an image control signal during a row scanning is performed. Thus, the backlight 20 of the above-described embodiment that performs row scanning for the electron-emitting elements 21 allows a desired amount of electrons to be accumulated in a large number of electron-emitting elements 21 in a short time with low-cost circuitry. It is therefore possible to increase the number of sub-frame periods in one frame period and to increase the number of light emissions per frame.

The backlight 20 not only improves the gradation reproduction performance of the liquid crystal display 10, but also employs a video display technique depending on the type of the image to be displayed. That is, for example, here, video signals corresponding to two consecutive frames (two consecutive displayed images) with respect to time are compared. If a difference between these video signals is large, the displayed image is defined as a “moving picture image”. If the difference is small, the displayed image is defined as a substantially “still image”. When the displayed image is a “moving picture image”, the number of light emissions and the light emission timings are adjusted while considering delay in changing the liquid-crystal molecular orientation (the liquid crystal alignment) of liquid crystal display elements, thereby preventing blurring of the displayed image due to delay of the liquid crystal the liquid-crystal molecular orientation. When the display image is a “still image”, light is emitted in each sub-frame period, and the amount of light emission in each sub-frame period is controlled, thereby displaying a high-quality image with the maximum utilization of the above-described gradation reproduction performance.

Accordingly, in combination with a mechanism for identifying image types (moving picture image and still image), the backlight 20 can employ suitable display techniques for the individual video images, and thus, can provide higher-quality images (video images).

The present invention is not limited to the embodiments described above, and a variety of modifications may be made without departing from the scope of the present invention. For example, in the above-described embodiment, the single phosphor 24 is provided for the plurality of electron-emitting elements 21. A single phosphor may be provided for each of the electron-emitting elements 21. Further, the backlight 20 does not necessarily emit light once in each of the sub-frame periods Tsub. That is, as discussed above, light emission or non-light emission of the phosphor may be controlled depending on the required quality of the display image and so forth.

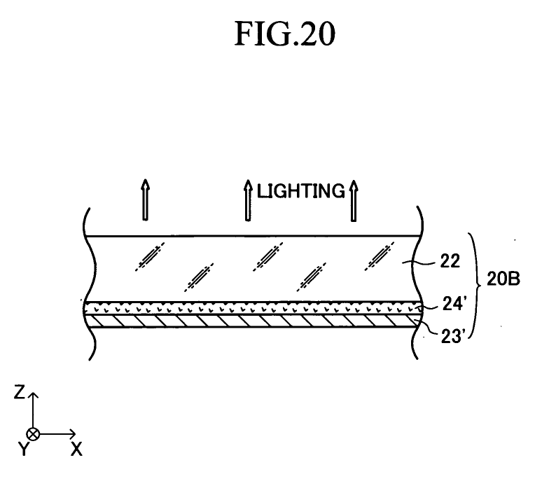

As shown in FIG. 20, the light-emitting section 20B may have a structure in which a phosphor 24′ is pre-formed on the lower surface of the transparent plate 22 (the surface facing the upper electrode 21d) and a collector electrode 23′ formed of an aluminum thin film of about 100 to 200 nm thickness is then formed so as to cover the phosphor 24′. In this case, electrons accelerated by an electric field generated by applying the collector voltage Vc reach the phosphor 24′ through the collector electrode 23′. With the structure, the collector electrode 23′ functions as a mirror for reflecting the light emitted from the phosphor 24′ toward the transparent plate 22. Thus, the light emitted from the phosphor 24′ can be efficiently transmitted to the outside.

Further, the phosphor 24 may be formed so as to be brought into contact with the upper electrode 21d on a surface of the upper electrode 21d opposite to the emitter section 21c. Therefore, a light-emitting element is constructed in which electrons emitted through the fine through-holes 21d1 of the upper electrode 21d collide with a phosphor disposed directly above the upper electrode 21d, thereby exciting the phosphor to emit light.

Furthermore, an electron-emitting device with a structure in which completely independent electron-emitting elements each including a lower electrode, an emitter section, and an upper electrode are arranged in a matrix on a substrate, the lower electrodes of the electron-emitting elements in an identical row being connected by an electrical conductor and the upper electrodes of the electron-emitting elements in an identical column being connected by an electrical conduct, may be used.

An upper electrode composed of an aggregate of flake-like materials (such as graphite) or an aggregate of electrically conductive materials including flake-like materials may be employed. Since an aggregate of such materials inherently has portions in which flakes are spaced apart from each other, those portions can be used as fine through-holes of the upper electrode without performing heat treatment, such as baking. Further, an organic resin and a metal thin film may be formed in the form of layers in the stated order on an emitter section and then baked to burn off the organic resin to form fine through-holes in the metal thin film, thereby forming an upper electrode.

What is claimed is:

1. A backlight used for a liquid crystal display including a plurality of liquid crystal display elements arranged in a matrix of n rows and m columns, in which the optical transmittance of each of the plurality of liquid crystal display elements is changed at every elapse of one frame period, thereby switching an image to be displayed by the plurality of liquid crystal display elements, the backlight comprising:
an electron-emitting device having a plurality of electron-emitting elements including:
an emitter section formed of a dielectric material;
a lower electrode disposed below the emitter section; and
an upper electrode disposed above the emitter section so as to face the lower electrode with the emitter section therebetween, the upper electrode having a plurality of fine through-holes,
wherein each of the electron-emitting elements accumulates an amount of electrons on the emitter section when a predetermined write voltage is applied between the upper electrode and the lower electrode, the amount of electrons accumulated corresponding to the magnitude of the predetermined write voltage, and emits the electrons accumulated on the emitter section through the fine through-holes from the emitter section when a predetermined electron emission voltage is applied between the upper electrode and the lower electrode, and
the electron-emitting elements are arranged in a matrix so that each of the electron-emitting elements faces each of liquid crystal display element groups including a plurality of the liquid crystal display elements of the liquid crystal display that are adjacent to each other;
a phosphor disposed between the upper electrode of the electron-emitting elements and the liquid crystal display so as to face the upper electrode, the phosphor emitting light by collisions with electrons; and
a drive voltage applying circuit for, in a sub-frame period which is one of a plurality of periods into which the one frame period is divided, determining a write voltage for each of the electron-emitting elements on the basis of the optical transmittances of the liquid crystal display elements belonging to the liquid crystal display element group that each of the plurality of electron-emitting elements faces with the phosphor therebetween, applying the determined write voltage to each of the electron-emitting elements, and, subsequently, applying the electron emission voltage to all of the plurality of electron-emitting elements.

2. The backlight according to claim 1, wherein the value n is a multiple of an integer N of 2 or more,
the value m is a multiple of an integer M of 2 or more,
the liquid crystal display element groups are arranged in a matrix of n/N rows and m/M columns, n/N being given by dividing n by N, m/M being given by dividing m by M,
the liquid crystal display is configured to perform an operation for changing the optical transmittances of all of the plurality of liquid crystal display elements in the one frame period by sequentially performing row scanning that needs a constant time, and
the sub-frame period is set to be a period needed for row scanning for the N rows of the liquid crystal display elements.

3. The backlight according to claim 1, wherein the drive voltage applying circuit is configured to, in each sub-frame period, apply the write voltage to all of the electron-emitting elements by sequentially performing row scanning in which the write voltage is applied simultaneously to electron-emitting elements belonging to an identical row in the electron-emitting elements arranged in the matrix, and, thereafter, to apply the electron emission voltage simultaneously to all of the electron-emitting elements.

4. The backlight according to claim 2, wherein the drive voltage applying circuit is configured to, in each sub-frame period, apply the write voltage to all of the electron-emitting elements by sequentially performing row scanning in which the write voltage is applied simultaneously to electron-emitting elements belonging to an identical row in the electron-emitting elements arranged in the matrix, and, thereafter, to apply the electron emission voltage simultaneously to all of the electron-emitting elements.

5. A lighting control method for a backlight used for a liquid crystal display including a plurality of liquid crystal display elements arranged in a matrix of n rows and m columns, in which the optical transmittance of each of the plurality of liquid crystal display elements is changed at every elapse of one frame period, thereby switching an image to be displayed by the plurality of liquid crystal display elements, the backlight comprising an electron-emitting device having a plurality of electron-emitting elements including an emitter section formed of a dielectric material, a lower electrode disposed below the emitter section, and an upper electrode disposed above the emitter section so as to face the lower electrode with the emitter section therebetween, the upper electrode having a plurality of fine through-holes, wherein each of the electron-emitting elements accumulates an amount of electrons on the emitter section when a predetermined write voltage is applied between the upper electrode and the lower electrode, the amount of electrons accumulated corresponding to the magnitude of the predetermined write voltage, and emits the electrons accumulated on the emitter section through the fine through-holes from the emitter section when a predetermined electron emission voltage is applied between the upper electrode and the lower electrode, and the electron-emitting elements are arranged in a matrix so that each of the electron-emitting elements faces each of liquid crystal display element groups including a plurality of the liquid crystal display elements of the liquid crystal display that are adjacent to each other; and a phosphor disposed between the upper electrode of the electron-emitting elements and the liquid crystal display so as to face the upper electrode, the phosphor emitting light by collisions with electrons,
the lighting control method comprising, in a sub-frame period which is one of a plurality of periods into which the one frame period is divided, determining a write voltage for each of the electron-emitting elements on the basis of the optical transmittances of the liquid crystal display elements belonging to the liquid crystal display element group that each of the plurality of electron-emitting elements faces with the phosphor therebetween, applying the determined write voltage to each of the electron-emitting elements, and, subsequently, applying the electron emission voltage to all of the plurality of electron-emitting elements.

6. The lighting control method for the backlight according to claim 4, wherein the value n is a multiple of an integer N of 2 or more,
the value m is a multiple of an integer M of 2 or more,
the liquid crystal display element groups are arranged in a matrix of n/N rows and m/M columns, n/N being given by dividing n by N, m/M being given by dividing m by M,
the liquid crystal display is configured to perform an operation for changing the optical transmittances of all of the plurality of liquid crystal display elements in the one frame period by sequentially performing row scanning that needs a constant time, and
the sub-frame period is set to be a period needed for row scanning for the N rows of the liquid crystal display elements.

7. The lighting control method for the backlight according to claim 5, wherein, in each sub-frame period, the write voltage is applied to all of the electron-emitting elements by sequentially performing row scanning in which the write voltage is applied simultaneously to electron-emitting elements belonging to an identical row in the electron-emitting elements arranged in the matrix, and, thereafter, the electron emission voltage is applied simultaneously to all of the electron-emitting elements.

8. The lighting control method for the backlight according to claim 6, wherein, in each sub-frame period, the write voltage is applied to all of the electron-emitting elements by sequentially performing row scanning in which the write voltage is applied simultaneously to electron-emitting elements belonging to an identical row in the electron-emitting elements arranged in the matrix, and, thereafter, the electron emission voltage is applied simultaneously to all of the electron-emitting elements.

9. The backlight according to claim 1, wherein absolute value of the predetermined write voltage required to accumulate electrons on the emitter section is smaller that absolute value of the predetermined electron emission voltage required to emit the electrons accumulated on the emitter section.

10. The backlight according to claim 2, wherein absolute value of the predetermined write voltage required to accumulate electrons on the emitter section is smaller that absolute value of the predetermined electron emission voltage required to emit the electrons accumulated on the emitter section.

11. The backlight according to claim 3, wherein absolute value of the predetermined write voltage required to accumulate electrons on the emitter section is smaller that absolute value of the predetermined electron emission voltage required to emit the electrons accumulated on the emitter section.

12. The backlight according to claim 4, wherein absolute value of the predetermined write voltage required to accumulate electrons on the emitter section is smaller that absolute value of the predetermined electron emission voltage required to emit the electrons accumulated on the emitter section.

13. The lighting control method according to claim 5, wherein absolute value of the predetermined write voltage required to accumulate electrons on the emitter section is smaller that absolute value of the predetermined electron emission voltage required to emit the electrons accumulated on the emitter section.

14. The lighting control method according to claim 6, wherein absolute value of the predetermined write voltage required to accumulate electrons on the emitter section is smaller that absolute value of the predetermined electron emission voltage required to emit the electrons accumulated on the emitter section.

15. The lighting control method according to claim 7, wherein absolute value of the predetermined write voltage required to accumulate electrons on the emitter section is smaller that absolute value of the predetermined electron emission voltage required to emit the electrons accumulated on the emitter section.

16. The lighting control method according to claim 8, wherein absolute value of the predetermined write voltage required to accumulate electrons on the emitter section is smaller that absolute value of the predetermined electron emission voltage required to emit the electrons accumulated on the emitter section.
